(19) United States
(12) Patent Application Publication
(10) Pub. No.: US 2009/0139107 A1
(43) Pub. Date: Jun. 4, 2009

(54) Exhaust air dryer with a heat pump and a first fan

(75) Inventors: Klaus Grunert, Berlin (DE); Thomas Nawrot, Berlin (DE); Guenter Steffens, Dallgow-Doeberitz (DE); Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 12/313,072

(22) Filed: Nov. 17, 2008

(30) Foreign Application Priority Data
Nov. 30, 2007 (DE) 10 2007 057 766.6

(51) Int. Cl. F26B 19/00; D06F 58/04

(52) U.S. Cl. 34/86; 34/132

(57) ABSTRACT

The invention relates to an exhaust air dryer with a drying compartment for objects to be dried, a supply air duct upstream of the drying compartment, a first fan for the supply of process air from a supply air inlet to the drying compartment and to an exhaust air outlet, an exhaust air duct between the drying compartment and the exhaust air outlet and a heat pump, with a heat sink in the exhaust air duct and a heat source in the supply air duct, characterized in that the first fan in the supply air duct is arranged between the supply air inlet and the heat source and a second fan in the supply air duct is arranged between the heat source and the drying compartment.

### BACKGROUND OF THE INVENTION

The invention relates to an exhaust air dryer with a drying compartment for objects to be dried, an supply air duct upstream of the drying compartment, a first fan for the supply of process air from a supply air inlet to a drying compartment and to an exhaust air outlet, an exhaust air duct between the drying compartment and the exhaust air outlet and a heat pump with a heat sink in the exhaust air duct and a heat source in the supply air duct.

Such an exhaust air dryer emanates from a short extract relating to the patent publication JP 2004 089415 A which can be taken from the database “Patent Abstracts of Japan”.

A tumble dryer is generally operated as an exhaust air dryer or condensation dryer. An exhaust air dryer only provides a flow of heated process air, which is routed once through the laundry placed in a drying compartment, absorbs the moisture from the laundry and then purges it out of the exhaust air dryer. Such purging is generally carried out by means of an exhaust air tube, in order to prevent moisture from the exhaust air in the building, in which the exhaust air dryer is positioned, from condensing. A condensation dryer, the functionality of which is based on the condensation of the moisture from the laundry which is condensed by means of warm process air, repeatedly passes the process air over the laundry to be dried, but does not require an exhaust air tube and in this way also allows energy to be recovered from the heated process air, for instance by using a heat pump.

With an exhaust air dryer, the air loaded with moisture after passing through a laundry drum is routed out of the dryer, with heat generally not being recovered. An exhaust air dryer with heat recovery is known in each instance from the brief extract cited in the introduction and the document DE 30 00 865 A1. In the case of an exhaust air dryer with heat recovery, ambient air (from e.g. 20° C. and 60% relative air humidity; so-called supply air) flows into an air-to-air heat exchanger or a heat pump and is heated there by cooling the warm process air coming from the drying compartment. The humid process air is cooled in the heat exchanger (e.g. air-to-air heat exchanger), so that the water contained in the humid process air condenses. Condensate develops as a function of the cooling power and/or the heat exchange, said condensate being collected in a container (condensate trough) for subsequent removal or pumped away.

The use of a heat pump or a heat exchanger in an exhaust air dryer allows a considerable amount of expended energy to be saved. In the case of a dryer equipped with a heat pump of the conventional compressor type, the warm process air loaded with moisture is generally cooled in an evaporator, which forms a heat sink of the heat pump. A coolant of the heat pump which is evaporated as a result of the heating process is fed by way of a compressor to a condenser forming a heat source of the heat pump, where heat is released as a result of the condensation of the gaseous coolant, said heat being used to heat up the process air prior to entry into the laundry drum.

DE 40 23 000 C2 describes a tumble dryer with a heat pump, with which a supply air opening is arranged in the process air duct between the condenser and the evaporator, it being possible to close said air supply opening using a controllable closure device.

A condensation dryer with a closed drying air circuit, which is equipped with a heat pump, is described in DE 197 38 735 C2. The heat pump is embodied as a device which operates according to the absorber principle, the absorber of which forms a third heat exchanger, the primary circuit of which is passed through by a coolant and by way of which secondary circuit the drying air flowing away from the second heat exchanger is fed again to the secondary circuit of the first heat exchanger.

A program-controlled tumble dryer is also described in DE 43 06 217 B4, in which the process air is fed into a closed process air duct by means of a fan, in which air duct closure devices arranged in a specific manner are located. The closure devices are suitably actuated as a function of the operating state (heating phase, tumble drying phase, reaching the maximum permissible temperature).

A fan for conveying the process air (supply air and exhaust air) is generally used in an exhaust air dryer. In addition, a conventional exhaust air dryer, like a conventional condensation dryer, generally has a motor, which collectively powers both the drying compartment (laundry drum) as well as the fan.

### SUMMARY OF THE INVENTION

When using a heat pump in a condensation dryer, the heat exchangers of the heat pump, i.e. evaporator and condenser, are normally arranged one behind the other so that they can be passed through in a straight fashion consecutively by the process air. This provides for a very efficient and space-saving arrangement of the components of the dryer. The installation of a heat pump in an exhaust air dryer is however associated with considerably more effort, since in an exhaust air drier with a heat pump, the condenser and evaporator, in the event of heat recovery from the exhaust air of the dryer, are clearly functionally separated from one another and also have to be connected to the air ducts. This is usually due to the costs relating to the size of the heat exchangers and thus the efficiency thereof.

An object of the present invention is thus to provide an exhaust air dryer with a heat pump, which can also operate effectively in the event of an unfavorable arrangement of the heat exchangers of the heat pump.

The subject matter of the invention is thus an exhaust air dryer with a drying compartment for objects to be dried, a supply air duct upstream of the drying compartment, a first fan for the supply of process air from a supply air inlet to the drying compartment and to an exhaust air outlet, an exhaust air duct between the drying compartment and the exhaust air outlet and a heat pump with a heat sink in the exhaust air duct and a heat source in the supply air duct, with, in accordance with the invention, the first fan in the supply air duct being arranged between the supply air inlet and the heat source and a second fan in the supply air duct being arranged between the heat source and the drying compartment.

The invention uses two fans connected one behind the other in order to achieve a high flow rate for the necessary process air even in a disadvantageous arrangement of the heat source and heat sink. This is advantageous in that with consistent thermal power, the flow rate of process air can be increased and as a result a faster drying of the objects present can be achieved. On the basis of the higher speed of the process air as a result of the increased flow rate, the heat transfers between the process air and the components of the heat pump are also improved, as a result of which the heat pump can operate more effectively. As a result, a shortening of the drying time in the inventive dryer is achieved.

The drying compartment is preferably a drum which can be rotated by means of a motor.

The heat sink and the heat source are likewise preferably an evaporator and a condenser respectively, the heat pump has a compressor and an air regulator, which are combined with the evaporator and the condenser to form a closed loop for a coolant. This heat pump is known as a “compressor heat pump”. The air regulator can be an regulating stop valve or an expansion valve, a capillary tube or a nozzle. The coolant is preferably selected from the group comprising the coolants R134a, R152a, R290, R407C and R410A. All said coolants aside from R290 are fluorinated hydrocarbons and/or mixtures of fluorinated hydrocarbons; R290 is the hydrocarbon propane, which is however relatively easily flammable due to its technical properties in the present context but would be very suitable as a coolant and is to this end very environmentally safe.

It is noted that the invention is not restricted to a certain type of heat pump, the prior art knows many different heat pumps in addition to the compressor heat pump, which are all considered for use within the scope of the invention, provided they enable the temperatures required for drying objects, in particular items of laundry, to be generated with an adequate thermal power.

The air flow rate from the first and second fan (V₁ and V₂) can vary widely. The air flow rate of the first fan V₁ is however preferably less than the air flow rate of the second fan V₂. The air flow rate of the first fan V₁ is preferably between 30 and 200 m³/h, in particular between 50 and 150 m³/h, and the air flow rate of the second fan V₂ between 150 and 850 m³/h, in particular between 200 and 750 m³/h.

In one embodiment of the invention, an additional heating option for heating the supply air is used in addition to the heat source of the heat pump. A heater is preferably provided here in the supply air duct of the exhaust air dryer. The heater includes in particular gas or electric heating.

Since the energy required for drying decreases with an advancing degree of drying of the objects to be dried in the exhaust air dryer, the heater is expediently controlled accordingly, i.e. with an advancing degree of drying, the heating power of the heater is reduced. It is particularly preferable to use the heating only in a heating phase immediately after start-up of the exhaust air dryer and as far as possible to only use the heat pump to apply the necessary heating power.

In the inventive exhaust air dryer, only a single motor is particularly preferably used. In a preferred embodiment of the invention, the first fan V₁ and the second fan V₂ are thus operated by the same motor. The first fan V₁ and the second fan V₂ are preferably arranged here on opposite sides of the motor. One development is particularly preferred, in which the single motor also powers the drying compartment embodied as a rotatable drum.

The inventive exhaust air dryer is advantageous in that the heat exchanger of the heat pump can operate very efficiently, in particular in an energy-efficient manner. Moreover, the invention provides for a quick heating of the supply air. To this end, a flow of supply air can be suitably varied by the use of two fans. For instance, the use of a single fan allows a small flow of supply air to be heated up to a desired temperature. If this is achieved, the flow of supply air can be increased by connecting an additional fan.

### BRIEF DESCRIPTION OF THE DRAWINGS

Exemplary embodiments of the invention result from the description of an exhaust air dryer which follows and a method for operating said exhaust air dryer, with reference being made to FIGS. 1 and 2.

FIG. 1 shows a perpendicular cross section of an exhaust air dryer (also abbreviated below to “dryer”), in which a heater is arranged inter alia in the supply air duct alongside the first and second fan.

FIG. 2 shows a schematic section from an embodiment of an exhaust air dryer. The connecting lines between the drying compartment and a first and second fan are to illustrate the realization of a single motor concept. The heater is omitted here.

### DETAILED DESCRIPTION OF EXEMPLARY EMBODIMENTS

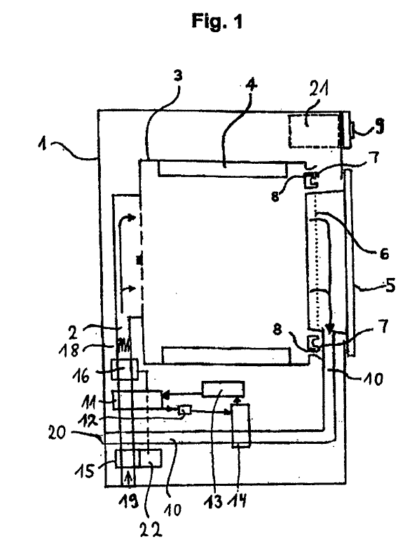

The dryer illustrated in FIG. 1 has a drum 3 which can be rotated about a horizontal axis as a drying compartment 3, within which attachments 4 for moving laundry during the rotation are fastened. Supply air is taken in from a supply air inlet 19 by means of a first fan (V₁) 15 and after passing through the condenser 11, which is the heat source 11 of a heat pump 11,12,13,14, is pushed into the drying compartment 3 by means of a second fan (V₂) 16. In the embodiment illustrated in FIG. 1, the supply air is heated up by means of the condenser 11 and a heater 18 (embodied here as an electrical resistance heater 18) and is guided into the drum 3 as heated supply air.

The heat transmitted by the condenser 11 originates from the evaporator 14, in which the warm air loaded with moisture which comes from the drum 3 is cooled by evaporating a coolant. After passing through the evaporator 14, the cooled air is fed to the exhaust air outlet 20 by way of the exhaust air duct 10. It is thus to be expected that the cooling of the air in the evaporator 14 is controlled to such a degree that moisture contained as steam condenses out and settles as a liquid condensate. Allowance is knowingly made for the controlled collection of such a condensate for subsequent removal; corresponding means are not shown for overview purposes.

The coolant of the heat pump 11, 12, 13, 14 which is evaporated in the evaporator 14 is routed to the condenser 11 by way of a compressor 13. The coolant liquefies in the condenser 11 by emitting heat to the supply air entering through the supply air inlet 19 in the supply air duct 2. The coolant now present in liquid form is in turn routed via a regulating stop valve 12 to the evaporator 14, as a result of which the coolant circuit is closed.

The heated supply air described above is routed from the side of the drum 3 facing a door 5 through its perforated base into the drum 3 and comes into contact there with laundry to be dried. After exiting the drum 3, the warm process air loaded with moisture is cooled in the evaporator 14 as exhaust air in the exhaust air duct 10. To this end, the warm process air firstly flows through the filler opening of the drum 3 to a lint filter 6 within a door 5 sealing the filler opening. The air flow in the door 5 is then diverted downwards and routed in the exhaust air duct 10 to the evaporator 14, where contained moisture condenses out as described. The dehumidified exhaust air is then routed into the installation compartment of the dryer 1 by way of the exhaust air outlet 20.

In the embodiment shown in FIG. 1, the drum 3 is mounted on the rear base by means of a pivot bearing and on the front by means of an end shield 7, with the drum 3 with a flange resting on a sliding strip 8 on the end shield 7 and thus being held on the front end. The exhaust air dryer is controlled by way of a control device 21, which can be controlled by the user by way of a control unit 9.

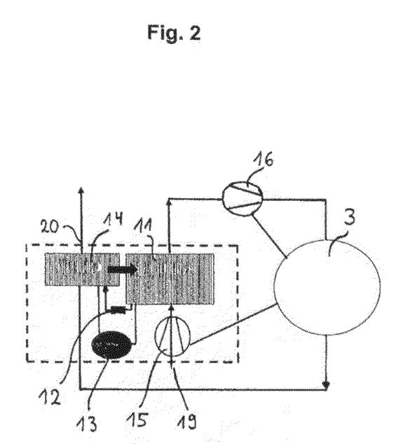

FIG. 2 shows a schematic section of a further embodiment of an inventive exhaust air dryer. With the embodiment shown in FIG. 2, the heater is omitted. The supply air is taken in from the installation compartment of the exhaust air dryer by way of the supply air inlet 19 with the aid of the first fan (V₁) 15 and is conveyed to the drying compartment 3 after passing through the evaporator 11 of the heat pump with the aid of the second fan (V₂). The connecting lines between the drum 3 and the first fan 15 as well as the second fan 16 are to illustrate the realization of a single motor concept, in which the first fan 15, the second fan 16 and the drum 3 are driven by a motor 22 (not shown here), (see FIG. 1).

1. An exhaust air dryer with a drying compartment for objects to be dried, the dryer comprising:
a supply air duct upstream of the drying compartment;
a first fan for the supply of process air from a supply air inlet to the drying compartment and to an exhaust air outlet;
an exhaust air duct between the drying compartment and the exhaust air outlet;
a heat pump with a heat sink in the exhaust air duct;
a heat source in the supply air duct, wherein the first fan in the supply air duct is between the supply air inlet and the heat source; and
a second fan in the supply air duct between the heat source and the drying compartment.

2. The exhaust air dryer of claim 1, wherein the drying compartment comprises a drum that is rotatable by a motor.

3. The exhaust air dryer of claim 1, wherein the heat sink comprises an evaporator and the heat source comprises a condenser, wherein the heat pump comprises a compressor and a regulating stop valve, which form a closed loop for a coolant with the evaporator and the condenser.

4. The exhaust air dryer of claim 3, wherein the coolant comprises one of R134a, R152a, R290, R407C, and R410A.

5. The exhaust air dryer of claim 1, wherein an air flow rate of the first fan is less than an air flow rate of the second fan.

6. The exhaust air dryer of claim 1, wherein an air flow rate of the first fan is between 30 and 200 m³/h and an air flow rate of the second fan is between 150 and 850 m³/h.

7. The exhaust air dryer of claim 6, wherein an air flow rate of the first fan is between 50 and 150 m³/h and an air flow rate of the second fan is between 200 and 750 m³/h.

8. The exhaust air dryer of claim 1, further comprising a heater in the supply air duct.

9. The exhaust air dryer of claim 8, wherein the heater comprises a gas or electric heater.

10. The exhaust air dryer of claim 1, wherein the first fan and the second fan are operated by the same motor.

11. The exhaust air dryer of claim 10, wherein the first fan and the second fan are on opposite sides of the motor.

12. The exhaust air dryer of claim 10, wherein the same motor also powers a rotatable drum of the drying compartment.
